(19) United States
(12) Patent Application Publication
(10) Pub. No.: US 2016/0167529 A1
(43) Pub. Date: Jun. 16, 2016

(54) PEDELEC POWER SYSTEM AND HOUSING THEREOF

(71) Applicant: INDUSTRIAL TECHNOLOGY RESEARCH INSTITUTE, Hsin-chu (TW)

(72) Inventors: SHAO-YU LI, Hsinchu County (TW); CHIN- PIN CHIEN, Hsinchu County (TW); MIN-CHUAN WU, Hsinchu (TW)

(21) Appl. No.: 14/960,607

(22) Filed: Dec. 7, 2015

(30) Foreign Application Priority Data
Dec. 12, 2014 (TW) 103143547

(51) Int. Cl. B60L 11/18; H02K 9/22; H02K 7/116

(52) U.S. Cl. CPC B60L 11/18; H02K 7/116; H02K 9/22

(57) ABSTRACT

A pedelec power system and housing thereof, which comprises: a first receiving portion, a plurality of connecting structures, a plurality of second receiving portions and a plurality of thermally conductive elements. The plurality of connecting structures and second receiving portions interlaced arranged surrounding the first receiving portion; at least one thermally conductive element is disposed in each connecting structure. A motor is arranged in the first receiving portion, a reduction device and a power electronic unit is arranged in the housing, and the reduction device and power electronic unit is coupled to the motor. At least one battery is arranged in each the second receiving portion.

### CROSS REFERENCE TO RELATED APPLICATION

This application also claims priority to Taiwan Patent Application No. 103143547 filed in the Taiwan Patent Office on Dec. 12, 2014, the entire content of which is incorporated herein by reference.

### TECHNICAL FIELD

The present disclosure relates to a pedelec power system and housing thereof, and more particularly, to a housing for a pedelec power system that is equipped with connecting structures arranged coupling to thermally conductive elements, and thereby, heat generated from an operating motor housed inside the housing can be dissipated into atmosphere for preventing the motor from overheating.

### BACKGROUND

A pedelec (from pedal electric cycle) is a bicycle where the rider's pedaling is assisted by a small electric motor that can be powered by batteries. Nevertheless, as conventional pedelecs generally adopt external batteries, not only the overall design of such pedelecs can be greatly restricted by the shape of the external battery, but also there can be more connecting wiring hanging on the outside of the pedelec frame. Therefore, it is common for a pedelec to integrate batteries with its powertrain, while the powertrain can be consisted of motors, a reduction device, and power electronic units. However, when the motor is buried deep inside the integrated system of the powertrain and batteries, the motor overheating problem can be inevitable and must be resolved as the batteries is generally being placed surrounding the periphery of its motor in a circular shape matching with the general shape of the gear set and hub.

Conventionally, the overheating problem is addressed by the formation of T-shaped heat dissipation fins on the housing of a motor, as there are ventilation grooves to be formed between the fins for dissipating heat out of the motor. Nevertheless, when the motor is being buried deep inside the integrated module of a pedelec power system which includes motors, batteries, controller and reducers, the heat that is dissipated from the motor's housing can be blocked and trapped by the other components built surrounding the motor.

In addition, although a conventional motor with heat dissipation fin can be either air cooled or water cooled, such air-cooled means or water-cooled means may not be efficient enough when all the powertrain components in a pedelec, including motor, battery, controller, and reduction device, are being integrated into a single module.

Therefore, it is in need of a pedelec power system and housing thereof that is simple in structure and also is efficient in heat dissipation.

### SUMMARY

In an embodiment, the present disclosure provides a pedelec power system, which comprises: a housing, a motor, a reduction device, a power electronic unit and a plurality of batteries. The housing further comprises: a first receiving portion, a plurality of connecting structures, a plurality of second receiving portions and a plurality of thermally conductive elements. The plurality of connecting structures and second receiving portions interlaced arranged surrounding the first receiving portion while enabling each connecting structure to have at least one thermally conductive element selected from the plural thermally conductive elements to be disposed therein. The motor and the reduction device and is arranged in the first receiving portion, and the power electronic unit is arranged in the housing, while enabling the reduction device and power electronic unit to couple to the motor. In addition, there is at least one battery selected from the plural batteries to be arranged in each of the plural second receiving portions.

In an embodiment, the present disclosure provides a housing for a pedelec power system, which comprises: a first receiving portion, a plurality of connecting structures, a plurality of second receiving portions and a plurality of thermally conductive elements, wherein the plurality of connecting structures and second receiving portions interlaced arranged surrounding the first receiving portion while enabling each connecting structure to have at least one thermally conductive element selected from the plural thermally conductive elements to be disposed therein.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a sectional view of a pedelec power system according to an embodiment of the present disclosure.

FIG. 2 is a front view of a housing for a pedelec power system according to an embodiment of the present disclosure.

FIG. 3 is an A-A sectional view of FIG. 2.

FIG. 4 is a schematic diagram showing various thermally conductive elements used in the present disclosure.

FIG. 5 is a schematic diagram showing the application of a pedelec power system of the present disclosure on a pedelec.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

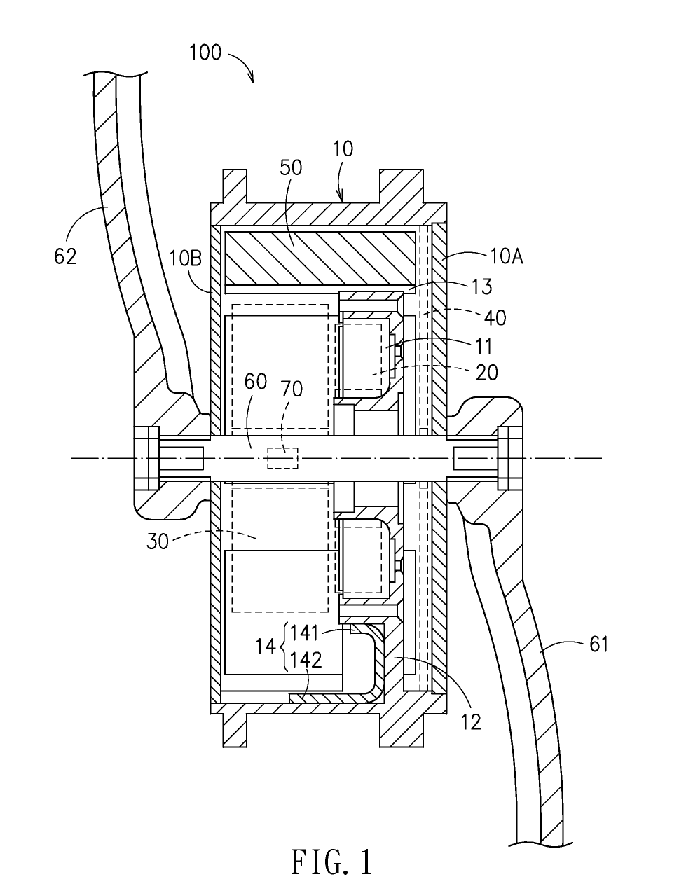

As shown in FIG. 1 to FIG. 3, the present disclosure provides a pedelec power system 100, which comprises: a housing 10, further comprising a first receiving portion 11, a plurality of connecting structures 12, a plurality of second receiving portions 13 and a plurality of thermally conductive elements 14. In this embodiment, the first receiving portion 11 is provided for housing a motor 20, while each of the second receiving portions 13 is provided for receiving a battery 50; and moreover, the housing 10 also has a reduction device 30 and a power electronic unit 40 disposed therein. Moreover, the pedelec power system of the embodiment adopts a central crank drive design.

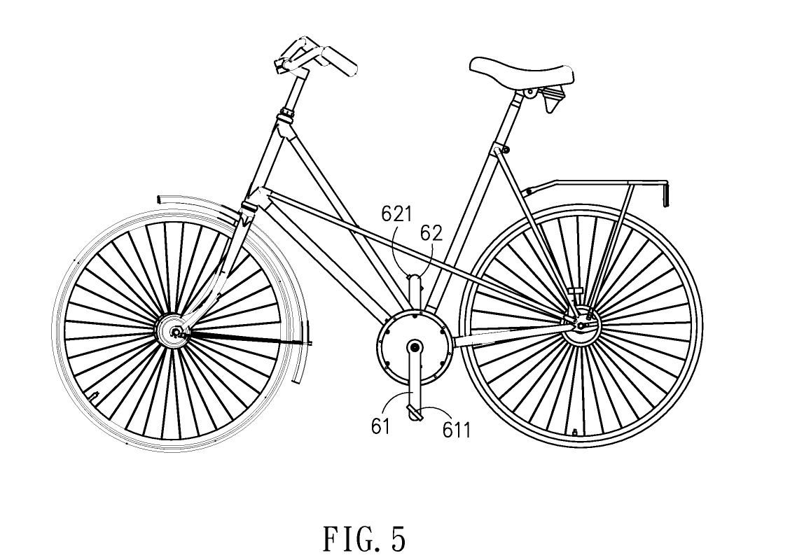

As shown in FIG. 1, the crankshaft 60 of a pedelec that is axially dispose in the housing 10 is arranged coaxially with the reduction device 30 and the motor 20, while allowing the reduction device 30 and the power electronic unit 40 to couple with the motor 20. In addition, there are cranks 61, 62 to be mounted on two opposite ends of the crankshaft 60, whereas the two cranks 61 are equipped respectively with pedals 611, 621 at the open ends thereof, as shown in FIG. 5. Thereby, a user is able to force the cranks 61, 62 to rotate by stepping on the pedals 611, 621, and the user's riding intent is detected by the sensor 70 and then the detection signal of the sensor 70 is sent to the power electronic unit 40 for controlling the power output of the motor 20. Thereafter, the power of the motor 20 is transmitted to the crankshaft 60 via the reduction device 30. It is noted that the motor 20 can be an axial flux motor or general radial flux motor, the reduction device 30 can be a double-stage planetary gear structure, and the sensor 70 can be a torque sensor. Moreover, for improving the rotation smoothness of the crankshaft 60, a bearing can be disposed at the joint of the crankshaft 60 and the housing 10, which is not shown in FIG. 1.

In FIG. 1, there are caps 10A, 10B to be disposed respectively at two ends of the housing 10, and the assembly of the housing 10 and two caps 10A, 10B forms a cylinder. By the covering of the two caps 10A, 10B, the reduction device 30 that is disposed inside the first receiving portion 11 and the power electronic unit 40 are disposed and enclosed inside the housing 10. However, the assembly of the housing 10 and two caps 10A, 10B can be formed into other shapes as required other than the cylinder, only if the following design essentials are fulfilled: the crankshaft is arranged coaxially with the reduction device and the motor; and the housing is configured with connecting structures that are arranged extending from the inside of the housing to the outside thereof, whereas each of the connecting structures can be fitted with thermally conductive elements or heat pipes, while allowing the connecting structures and the batteries to be interlaced arranged surrounding the periphery of the first receiving portion of the housing.

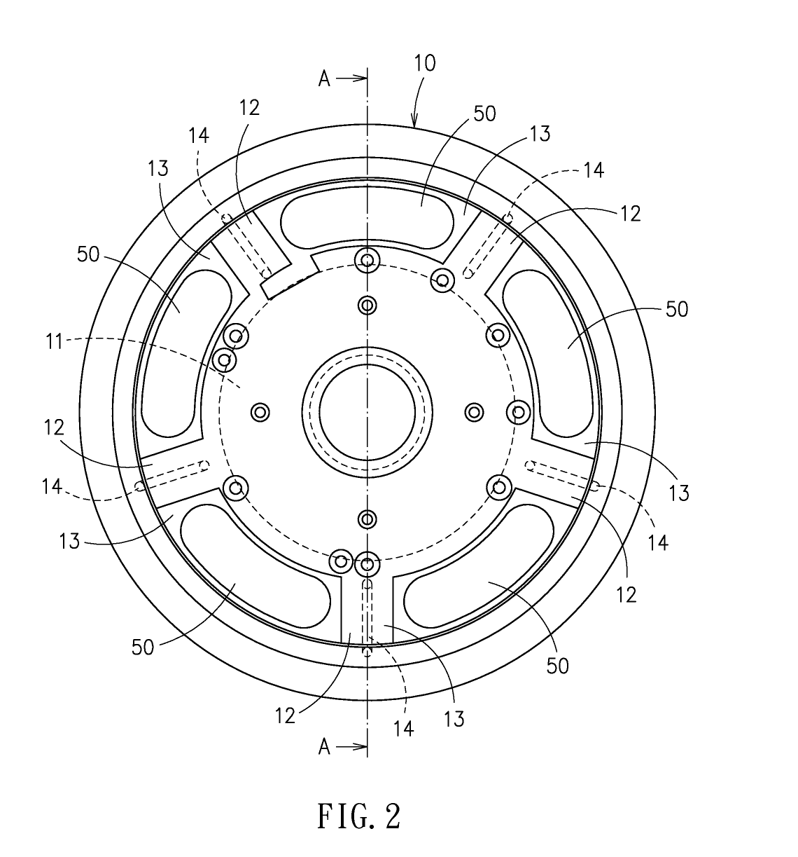

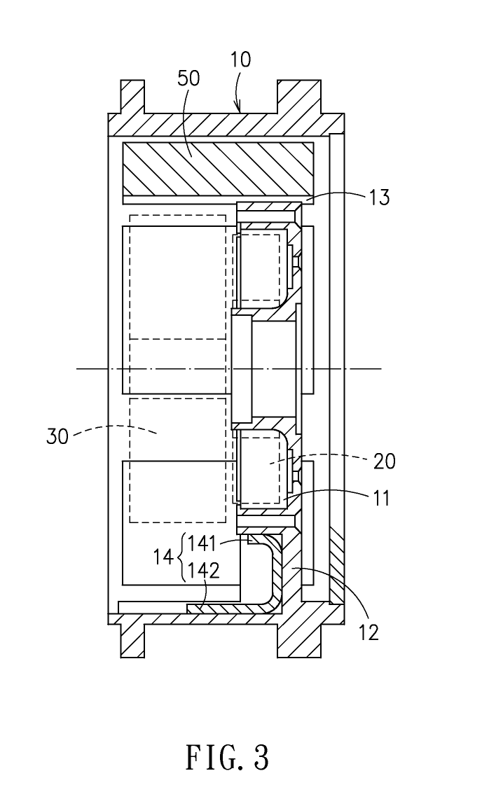

Please refer to FIG. 2 and FIG. 3, which are schematic views of a housing for a pedelec power system according to an embodiment of the present disclosure. In this embodiment, the housing 10 is a cylinder and thus the first receiving portion is shaped like a circular. Thereby, the periphery of the first receiving portion 11 can be a continuous ring-like structure, and the sides of the plural second receiving portions 13 that are disposed corresponding to the first receiving portion 11 are connected to one another into a continuous ring-like structure. In addition, the plural connecting structures 12 are radially arranged about the center of the first receiving portion 11 and surrounding the periphery of the first receiving portion 11. That is, the connecting structures 12 are used for connecting two concentric ring-like structures, while the second receiving portions 13 are interlaced arranged with the plural connecting structures 12 and surrounding the periphery of the first receiving portion 11. Moreover, there is one thermally conductive element 14 to be disposed inside each of the connecting structures 12.

Moreover, each of the plural thermally conductive elements 14 is configured with a first end 141 and a second end 142 that are arranged opposite to each other while enabling the first end 141 to extend toward the periphery of the first receiving portion 11 and the opposite second end 142 to extend toward a side of one of the second receiving portions 13 that is arranged corresponding to the first receiving portion 11. That is, for one thermally conductive element 14 that is disposed in one of the connecting structures 12, its first end 141 is disposed closer to the motor 20 while the second end 142 is disposed at a position away from the motor 20, and thereby, the heat from the operating motor 20 can be guided by the thermally conductive element 14 to flow from the motor 20 to the exterior of the housing 10. It is noted that the connecting structures 12 used in the present disclosure not only can be used as the supporting structures of the housing 10, but also they can act as the heat transmission paths guiding the heat of the motor 20 to dissipate into the atmosphere, so that the motor overheating problem can be solved.

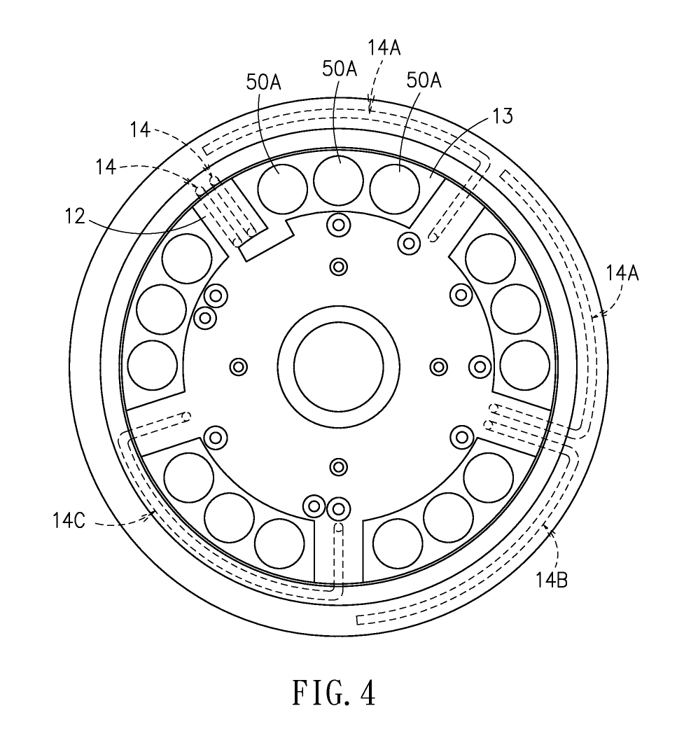

Please refer to FIG. 4, which is a schematic diagram showing various thermally conductive elements used in the present disclosure. As shown in FIG. 4, the thermally conductive elements 14A˜14C are slightly different from one another in shape, but are arranged for allowing one end thereof to be disposed closer to the first receiving portion 11, and the opposite end to be disposed away from the first receiving portion 11 and extend toward the periphery of one corresponding second receiving portion 13. In FIG. 4, there are two thermally conductive elements to be disposed in one connecting structure 12. Consequently, there can be more than one thermally conductive elements 14A˜14C to be disposed in one connecting structure 12. In addition, there are three small-sized batteries 50A to be disposed in one second receiving portion 13, as shown in FIG. 4. However, all the batteries 50A are arranged surrounding the periphery of the first receiving portion 11, that is the same as those shown in FIG. 1.

To sum up, in the pedelec power system and housing thereof that are disclosed in the present disclosure, by the connecting structures that are equipped with thermally conductive elements, heat generated from an operating motor housed inside the housing can be dissipated into atmosphere for preventing the motor from overheating. Consequently, the heat that is dissipated from the motor's housing will not be blocked and trapped by the other components built surrounding the motor of the pedelec.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A pedelec power system, comprising:
a housing, further comprising:
a first receiving portion;
a plurality of connecting structures, arranged surrounding the periphery of the first receiving portion;
a plurality of second receiving portions, interlaced arranged with the plural connecting structures and surrounding the periphery of the first receiving portion; and
a plurality of thermally conductive elements, arranged for allowing each of the connecting structure to have at least one thermally conductive element selected from the plural thermally conductive elements to be disposed therein;
a motor, disposed in the first receiving portion;
a reduction device, disposed in the first receiving portion of the housing and coupled to the motor;
a power electronic unit, disposed in the housing and coupled to the motor; and
a plurality of batteries, arranged for allowing each of the second receiving portions to have at least one battery selected from the plural batteries to be disposed therein.

2. The pedelec power system of claim 1, wherein the first receiving portion is formed into a circular, while enabling the plural connecting structures to be radially arranged about the center of the first receiving portion and surrounding the periphery of the first receiving portion.

3. The pedelec power system of claim 1, wherein each of the plural thermally conductive elements is configured with a first end and a second end that are arranged opposite to each other while enabling the first end to extend toward the periphery of the first receiving portion and the opposite second end to extend toward a side of one of the second receiving portions that is arranged corresponding to the first receiving portion.

4. The pedelec power system of claim 1, wherein the periphery of the first receiving portion is formed into a continuous ring-like structure.

5. The pedelec power system of claim 1, wherein the sides of the plural second receiving portions are connected to one another into a continuous ring-like structure.

6. The pedelec power system of claim 5, further comprising:
a crankshaft, arranged coaxially with the reduction device and the motor.

7. The pedelec power system of claim 1, the pedelec power system adopts a central crank drive design.

8. A housing for a pedelec power system, comprising:
a first receiving portion;
a plurality of connecting structures, arranged surrounding the periphery of the first receiving portion;
a plurality of second receiving portions, interlaced arranged with the plural connecting structures and surrounding the periphery of the first receiving portion; and
a plurality of thermally conductive elements, arranged for allowing each of the connecting structure to have at least one thermally conductive element selected from the plural thermally conductive elements to be disposed therein.

9. The housing of claim 8, wherein the first receiving portion is formed into a circular, while enabling the plural connecting structures to be radially arranged about the center of the first receiving portion and surrounding the periphery of the first receiving portion.

10. The housing of claim 8, wherein each of the plural thermally conductive elements is configured with a first end and a second end that are arranged opposite to each other while enabling the first end to extend toward the periphery of the first receiving portion and the opposite second end to extend toward a side of one of the second receiving portions that is arranged corresponding to the first receiving portion.

11. The housing of claim 8, wherein the periphery of the first receiving portion is formed into a continuous ring-like structure.

12. The housing of claim 8, wherein the sides of the plural second receiving portions are connected to one another into a continuous ring-like structure.

13. The pedelec power system of claim 8, the pedelec power system adopts a central crank drive design.
